(19) United States
(12) Patent Application Publication
(10) Pub. No.: US 2007/0035158 A1
(43) Pub. Date: Feb. 15, 2007

(54) Deformable fixing element, in particular for a safety net for the cargo space of a motor vehicle

(76) Inventors: Aliki Plika, Goteborg (SE); Richard G. Lewis, Goteborg (SE)

Correspondence Address: FOLEY & LARDNER LLP, 777 EAST WISCONSIN AVENUE, MILWAUKEE, WI, 53202-5306, US

(21) Appl. No.: 10/570,720

(22) PCT Filed: Aug. 21, 2004
(86) PCT No.: PCT/EP04/09374

§ 371 Date: Mar. 3, 2006

(30) Foreign Application Priority Data
Sep. 5, 2003 (DE) 103 41 411.8

(51) Int. Cl. B60J 7/00

(52) U.S. Cl. 296/187.03

(57) ABSTRACT

A fixing element for connecting a first component to a second component, in particular for fixing a safety net in the cargo space of a motor vehicle is disclosed. The fixing element is deformable to absorb energy in the case of an excess load. The fixing element is provided with predetermined breaking points, at which the regions of the fixing element that are connected to the first and second components separate from one another in the local area of the breaking points.

### CROSS-REFERENCE TO RELATED APPLICATIONS

The present invention claims priority as a national stage application of International Patent Application Serial No. PCT/EP2004/009347 filed on Aug. 21, 2004; and German Patent Application Serial No. 10341411.8 filed on Sep. 5, 2003, which are hereby incorporated herein by reference in their entirety.

### FIELD

The invention relates to a fixing element for connecting a first component to a second component, in particular for fastening a safety net in the cargo space of a motor vehicle, said fixing element being deformable to absorb energy in the event of excess loads caused by a crash.

### BACKGROUND

A fixing element according to the generic type is disclosed in the publication EP 0 642 955 B1. It comprises bar-shaped connecting struts between vehicle body and safety net, which connecting struts are in each case provided with a deformation element in the form of a widening in the shape of a circular ring. Under excess load, the circular ring is deformed to form an ellipse and in the process absorbs energy.

A further fixing element according to the precharacterizing clause of claim 1 is disclosed in patent specification EP 0 777 590 B1. This comprises a fastening tab which is bent in an S-shaped manner, is secured in the region of the overlap by means of a clamping clip, expands in the event of an accident and is pulled out of the clamping clip.

Since fixing elements of this type absorb energy exclusively through deformation, the regions to be deformed have to be of relatively large and geometrically complex design, which means that these components take up a considerable amount of construction space. In addition, they are visually less attractive and are relatively complicated to manufacture.

### SUMMARY

The invention is based on the problem of providing a compact and elegant fixing element which is simple to produce and is capable of absorbing considerable energy.

The problem is solved according to the invention by the fixing element being provided with predetermined breaking points along which those regions of the fixing element which are connected to the first and to the second component are caused by the accident to separate from one another locally. The forces occurring because of the accident are therefore not only dissipated by plastic deformation but in particular by the energy required for tearing open the predetermined breaking points.

The predetermined breaking points are preferably designed as notches running linearly in a plate-like region of the fixing element. They may be impressed directly into the fixing element during punching thereof. Of course, other arrangements, for example a linear arrangement of blind or passage holes in a row next to one another and differing manufacturing methods (drilling, milling, eroding or the like), are also conceivable.

The remaining material cross section of the fixing element in the region of the notches is preferably smaller in that part of the predetermined breaking point(s) which is separable first than in that region of the predetermined breaking point(s) which is separable subsequently. This makes a relatively easy initial tearing possible while the absorption of energy increases during the further course of the separation. To this end, it is advantageous that the remaining cross section of the plate-like design increases continuously, in particular linearly, over the profile of the predetermined breaking point.

Of course, complete tearing off is generally to be avoided.

The force flux in the fixing element can be controlled by that region of the predetermined breaking point which is separable first exiting from an aperture through the fixing element.

The predetermined breaking points and/or the apertures are advantageously arranged in a U-shaped manner on the fixing element, the first component being connected to the fixing element outside the U-shaped arrangement and the second component being connected to the fixing element within the U-shaped arrangement, to be precise on the far side of the limb ends thereof. The separating process causes the fixing element to form a plastically deformed tab which is still connected fixedly to the fixing element in the region of the limb ends of the “U”.

### BRIEF DESCRIPTION OF THE FIGURES

The figures illustrate an embodiment of the invention by way of example and diagrammatically.

In the figures:

FIG. 1 shows a section through the cargo space of a motor vehicle which is equipped with a fixing element for a safety net,

FIG. 2 shows a top view of a fixing element according to the invention in an undeformed state,

FIG. 3 shows a first cross section XI-XI through the fixing element according to FIG. 2,

FIG. 4 shows a further cross section X2-X2 through the same fixing element,

FIG. 5 shows the fixing element according to FIG. 2 after deformation caused by an accident.

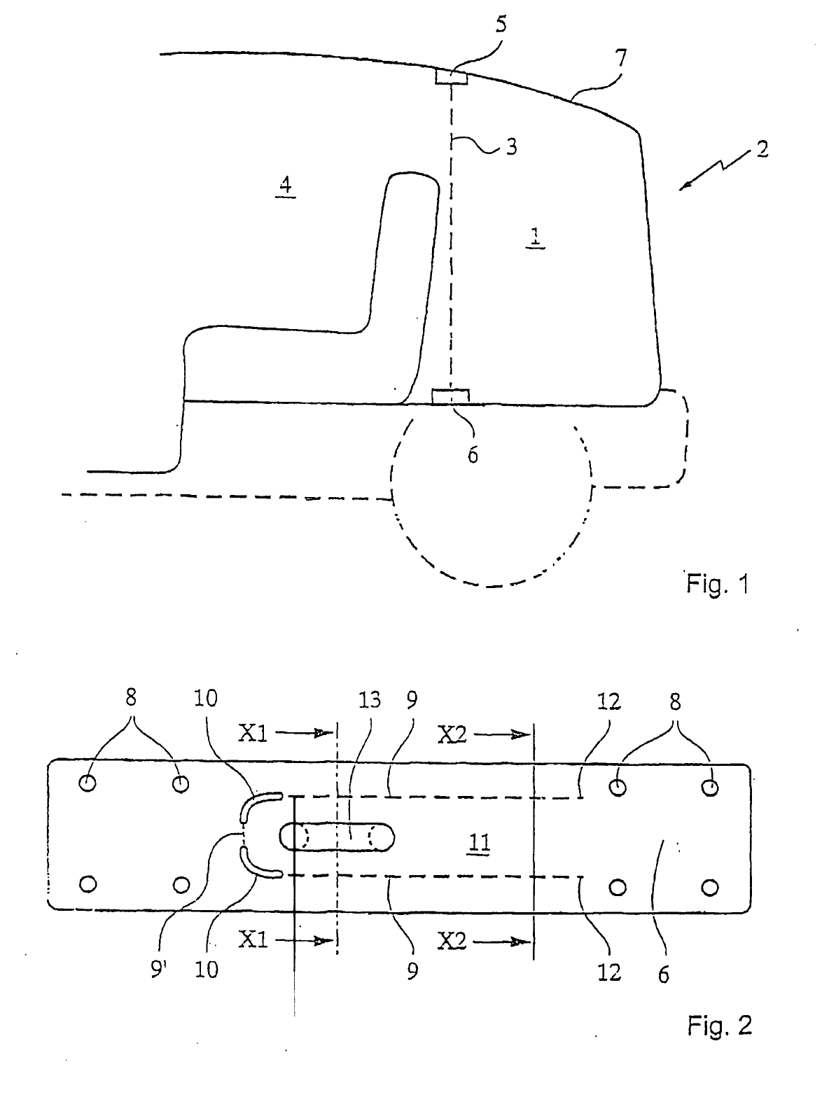

### DETAILED DESCRIPTION OF EXEMPLARY EMBODIMENTS

The cargo space 1 of the motor vehicle 2 illustrated in FIG. 1 is protected toward the passenger compartment 4 by a (usually removable) safety net 3, so that, in the case of a deceleration caused by an accident, cargo cannot penetrate into the passenger compartment 4 and injure the occupants.

The safety net 3 is connected to the body 7 of the motor vehicle 2 via upper fixing elements 5 and lower fixing elements 6, if appropriate also via lateral fixing elements (not illustrated). The lower fixing elements 6, which cannot in any way come into contact with the rear occupants, are preferably designed according to the invention. However, given an appropriate arrangement or covering, the use is not restricted to these fixing elements.

Each fixing element 6 comprises an elongate sheet-metal part provided at its ends with holes 8 for fastening to the vehicle body, for example by riveting or screwing. Between the holes 8, a U-shaped arrangement of linear predetermined breaking points 9, 9′ and curved apertures 10 extends in the central region of the fixing element 6. The U-shaped arrangement therefore surrounds a tab 11 which is integrated integrally in the fixing element 6 and is equipped with a clip 13 at its end situated on the far side of the limb ends 12. The safety net 3 is fitted with a hook-like counterpart into said clip.

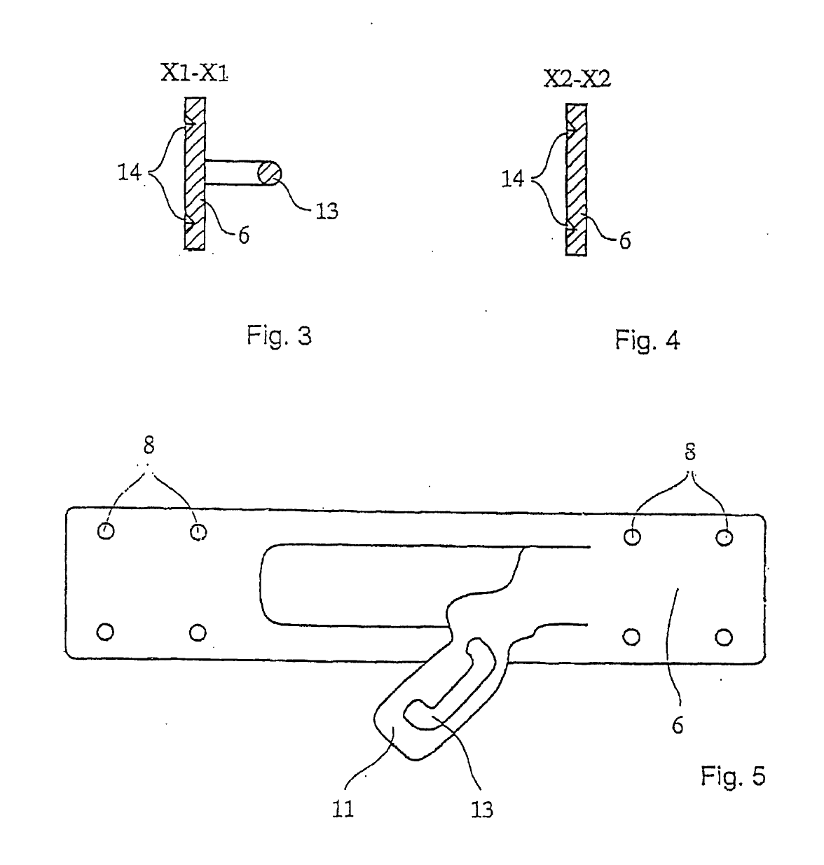

As is apparent from the cross sections according to FIG. 3 and FIG. 4, the predetermined breaking points 9 (likewise 9′) are formed by notches 14 impressed into the fixing element. These notches have a greater depth in the region of the clip 13 and of the apertures 10 (FIG. 3) than in the region of the limb ends 12 (FIG. 4), so that the remaining material cross section decreases from the clip 13 to the limb ends 12.

Of course, the notches 14 may also be impressed onto both flat sides of the fixing element 6, but for visual reasons an arrangement on one flat side which is no longer visible after installation is to be preferred.

In the case of an overload caused by an accident, a force acts on the fixing element, the force component of which, which is oriented orthogonally to the surface of the fixing element, is sufficient for initially tearing the predetermined breaking points 9, 9′ in the region of the apertures 10, as a result of which the tab 11 emerges in some regions from the plane of the fixing element. Over the further time sequence, the tab 11 continues to be peeled off, with the force required for this increasing further because of the profile of the notch depth.

Of course, after the end of the deformation (FIG. 5), the fixing element 6 can no longer be used and therefore has to be replaced.

### REFERENCE NUMBERS

1 Cargo space

2 Motor vehicle

3 Safety net

4 Passenger compartment

5 Fixing element (top)

6 Fixing element (bottom)

7 Body

8 Hole

9 Predetermined breaking point

10 Aperture

11 Tab

12 Limb end

13 Clip

14 Notch

1-6. (canceled)

7. An apparatus for providing a connection for a component in a vehicle interior, the apparatus comprising:
a plate having a first region and a second region, the first region coupled to the vehicle interior and the second region adapted to be coupled to the component;
predetermined breaking points located between the first region and the second region,
wherein the second region separates from the first region along the predetermined breaking points upon application of a force.

8. The apparatus of claim 7 wherein the predetermined breaking points comprise notches extending along the plate between the first region and the second region.

9. The apparatus of claim 8 wherein the notches comprise a first notch portion and a second notch portion, the first notch portion providing a first wall thickness between a bottom of the first notch portion and an opposite surface of the plate, the second notch portion providing a second wall thickness between a bottom of the second notch portion and the opposite surface of the plate, wherein the first wall thickness is less than the second wall thickness so that the first notch portion is separable before the second notch portion upon application of the force.

10. The apparatus of claim 9 wherein the cross-section of the plate increases continuously over the profile of the notches and progresses from the first notch portion to the second notch portion.

11. The apparatus of claim 8 wherein the notches are impressed into the plate.

12. The apparatus of claim 8 wherein the notches are located on opposing sides of the plate.

13. The apparatus of claim 7 wherein the predetermined breaking points comprise a first notch, a second notch, a third notch, a first curved aperture between the first notch and the second notch, and a second curved aperture between the second notch and the third notch, wherein the first notch, first curved aperture, second notch, second curved aperture, and third notch are provided in a U-shaped arrangement.

14. The apparatus of claim 13 wherein the first notch and third notch have a greater depth near the first and second apertures than at outer ends of the first and third notches so that the remaining material cross section increases from the first and second curved apertures to the ends of the U-shaped arrangement.

15. The apparatus of claim 13 wherein the force is sufficient for initially tearing the second notch so that the second region emerges from the plate.

16. The apparatus of claim 15 wherein the second region continues to be peeled away from the first region from the second notch towards the outer ends of the first and third notches upon application of force that is greater than the force that initially separated the second region from the first region at the second notch.

17. The apparatus of claim 13 wherein the U-shaped arrangement defines the second region.

18. The apparatus of claim 7 wherein the force applied to the second region is oriented orthogonally to a surface of the plate.

19. The apparatus of claim 7 wherein the second region is deformable to absorb energy in the event of excess force caused by an accident.

20. The apparatus of claim 7 wherein the second region is integrated integrally in the plate.

21. The apparatus of claim 20 wherein second region comprises a clip.

22. The apparatus of claim 21 wherein the component comprises a safety net fitted with a hook that is configured to couple to the clip and the vehicle interior is a cargo space of a vehicle.

23. The apparatus of claim 7 wherein the first region and the second region together comprise an elongate sheetmetal part.
